(19) United States
(12) Patent Application Publication
(10) Pub. No.: US 2016/0290368 A1
(43) Pub. Date: Oct. 6, 2016

(54) SERVO VALVES

(71) Applicant: BLAGDON ACTUATION RESEARCH LIMITED, Blagdon, Bristol (GB)

(72) Inventor: Andrew John COLLINS, Somerset (GB)

(73) Assignee: BLAGDON ACTUATION RESEARCH LIMITED, Blagdon, Bristol (GB)

(21) Appl. No.: 15/035,401

(22) PCT Filed: Nov. 14, 2014
(86) PCT No.: PCT/GB2014/053377

§ 371 Date: May 9, 2016

(30) Foreign Application Priority Data
Nov. 15, 2013 (GB) 1320192.6

(51) Int. Cl. F15B 13/04; F15B 13/044; F16K 31/06; F16K 11/07; F16K 31/08

(52) U.S. Cl. CPC F15B 13/0401; F16K 11/0716; F16K 31/082; F16K 31/0675; F15B 13/044; B33Y 10/00

(57) ABSTRACT

A servo valve for use with an actuator. The servo valve comprises a first set of internal ports including a first inlet port, a first outlet port, a first A-control port and a first B-control port and a second set of internal ports including a second inlet port, a second outlet port, a second A-control port and a second B-control port. The valve is arranged and configured such that in use each internal port is in fluid communication with the actuator.

### TECHNICAL FIELD

The present invention concerns improvements in and relating to servo valves.

### BACKGROUND OF THE INVENTION

Servo valves are used in a wide variety of industries to control the movement of hydraulic or pneumatic actuators in response to an input signal and are employed in industries where precise control of an actuator is required, for example in the aerospace industry. Servo valves alter the flow of a fluid through the valve in order to control the position, velocity, acceleration or force generated by an actuator, for example a hydraulic or pneumatic cylinder or motor.

A servo valve typically comprises a moving element (spool) and a fixed element (sleeve). The relative movement of these two elements controls the flow of fluid through the valve in response to a mechanical or electrical input signal.

Additive manufacture, also known as 3D printing, is a term applied to processes whereby three-dimensional articles are manufactured by building up successive layers of material in different shapes. This is in contrast to traditional manufacturing techniques (known as subtractive manufacturing) such as milling or boring in which material is removed in order to create the final form of an article. The flexibility offered by additive manufacturing techniques allows the design of servo valves to be approached differently. Redesigning a servo valve taking into account the possibilities offered by flexible manufacturing has resulted in an improved valve design which overcomes a number of longstanding issues associated with servo valves.

Many servo valves are used in applications where space is limited. Typically, reducing the size of the valve leads to a reduction in the maximum flow rate that can be achieved through the valve. Consequently, it would be advantageous to produce a servo valve that has an increased flow rate in comparison to its size and weight.

One of the components of the servo valve most instrumental in dictating the size of the valve is the valve motor. The size of the motor is often dictated by power/torque requirements. Consequently, it would be advantageous to improve the design of the servo valve motor such that a smaller valve may be produced.

In a rotary to linear servo valve the rotary motion of the motor is transformed into linear motion of the spool. Drive-train mechanisms have been developed capable of carrying out said transformation of motion but such mechanisms are complex and therefore prone to failure. Precise control of the position of the spool is required in order for a servo valve to function effectively. However, many existing designs involve line contact between the spool and the drive member which leads to wear on these components. This results in a reduction in the degree of precision with which the valve may be controlled and therefore a degradation in the performance of the valve over its lifetime. Consequently, it would be advantageous to produce a servo valve with an improved drive-mechanism.

Servo valves are complex pieces of equipment which require a high degree of precision during assembly. Consequently, it would be advantageous to produce a servo valve designed for improved ease and accuracy of assembly.

### SUMMARY OF THE INVENTION

According to a first aspect of the invention there is provided a servo valve for use with an actuator, the servo valve comprising a first set of internal ports including a first inlet port, a first outlet port, a first A-control port and a first B-control port and, a second set of internal ports including a second inlet port, a second outlet port, a second A-control port and a second B-control port, wherein the valve is arranged and configured such that in use each internal port is in fluid communication with the actuator.

Thus, a single valve comprises two sets of ports, both sets being associated with the same actuator. This may increase the fluid flow that can be achieved through the valve. Moreover, by associating two ports with the same actuator, the size of the individual ports may be smaller than in a valve with a single set of ports, whilst still maintaining the same fluid flow to the actuator. Smaller ports may be advantageous in that smaller control movements of the valve can be used to open and close the ports resulting, for example, in faster control.

The servo valve may be connected to a hydraulic system. The hydraulic system may include the actuator. The actuator may be a pneumatic cylinder. The actuator may be a hydraulic cylinder. The actuator may be a hydraulic motor. The servo valve may be connected to the hydraulic system such that the servo valve controls the flow of fluid to the actuator. The hydraulic system may include a pressurised supply. The hydraulic system may include a tank. The servo valve may be connected to the hydraulic system such that fluid flows from the pressurised supply to the actuator via the servo valve. The servo valve may be connected to the hydraulic system such that fluid flows from the actuator to tank via the servo valve. An internal port being “in fluid communication with” the actuator means that fluid may flow to or from the actuator via that port.

The servo valve may include a fluid manifold. The fluid manifold may include a cavity. The cavity may be substantially cylindrical. The cavity may be defined by an inner surface of the manifold. The internal ports may be located in the inner surface of the manifold.

The servo valve may include a spool. The spool may be located within the manifold cavity. The spool may be concentrically located within the manifold cavity. The inner surface of the manifold may define a cavity and the spool may be concentrically located within the cavity. The spool may be axially constrained within the manifold cavity. The position of the spool may determine the flow path of fluid through the valve.

Each internal port may be in fluid communication with the internal cavity. Each internal port may be categorised according to its function. Categories of internal port may include inlet ports, outlet ports and control ports. Fluid may flow into the cavity via an inlet port. Fluid may flow out of the cavity via an outlet port. Fluid may flow into the cavity via a control port. Fluid may flow out of the cavity via a control port. Thus, a control port may act as a fluid inlet and a fluid outlet. A control port may act as a fluid inlet or a fluid outlet depending on the position of the spool. Fluid flowing out of the cavity via a first control port may cause the actuator to move in a first output direction. Fluid flowing out of the cavity via a second control port may cause the actuator to move in a second output direction. The second output direction may be opposite to the first output direction. A control port may be categorised as an A-control port if fluid flowing out of the cavity via the port causes the actuator to move in the first output direction. A control port may be categorised as a B-control port if fluid flowing out of the cavity causes the actuator to move in the second output direction.

An inlet port may be in fluid communication with the actuator via the cavity and a control port. An outlet port may be in fluid communication with the actuator via the cavity and a control port.

The servo valve may include one or more external ports. For example the servo valve may include four external ports. The servo valve may be connected to the hydraulic system via the external ports. Each external port may be categorised according to its function. Categories of external ports may include supply pressure port, tank port, and external control port.

The servo valve may include a supply pressure port. The supply pressure port may be connected to the pressurised supply. An inlet port may be connected to the supply pressure port. The inlet port may be connected to the supply pressure port via the manifold. Thus, an inlet port may be in fluid communication with the supply pressure port such that fluid at pressure may enter the cavity.

The servo valve may include a tank port. The tank port may be connected to the tank. An outlet port may be connected to the tank port. The outlet port may be connected to the tank port via the manifold. Thus, the outlet port may be in fluid communication with the tank port such that fluid from the cavity is able to exit the servo valve to tank.

The servo valve may include an external control port. The servo valve may include two external control ports.

A control port may be connected to the external control port via the manifold. The control port may be in fluid communication with the external control port such that fluid from the cavity is able to exit the servo valve to the actuator. The control port may be in fluid communication with the external control port such that fluid from the actuator is able to enter the cavity. The servo valve may include an external A-control port. An external A-control port may be connected to the actuator such that fluid flowing out of the servo valve via the A-control port causes the actuator to move in the first actuator direction. The servo valve may include an external B-control port. An external B-control port may be connected to the actuator such that fluid flowing out of the servo valve via the B-control port causes the actuator to move in the second actuator direction.

The first set may include a plurality of internal ports. The first set may include a first inlet port, a first outlet port, a first A-control port and a first B-control port. The first set may include further internal ports.

The second set may include a plurality of internal ports. The second set may include a second inlet port, a second outlet port, a second A-control port and a second B-control port. The second set may include further internal ports.

A port performing a given function in one set may be said to correspond to a port performing the same function in any other set. Thus, the first inlet port corresponds to the second inlet port. Similarly, the first outlet port corresponds to the second outlet port.

In use, each internal port may be in fluid communication with the same hydraulic system. Thus, the internal ports of the first set and the internal ports of the second set may be in fluid communication with the same hydraulic system.

In use, each internal port may be in fluid communication with the same actuator. The internal ports of the first set and the internal ports of the second set may be involved in the control of the same actuator.

The manifold may include a plurality of flow galleries. The flow galleries may connect each internal port to an external port. A flow gallery may connect one or more internal ports to an external port. A flow gallery may branch into two sub-galleries. An individual sub-gallery may have a reduced cross-sectional area as compared to the gallery from which it branches off. The total cross-sectional area of the sub-galleries branching from a flow gallery may be equal to the cross-sectional area of that gallery. Thus, the overall cross-sectional area for the flow may be maintained after branching. A flow gallery may branch into more than two sub-galleries. For example, a flow gallery may branch into three sub galleries. Two or more sub-galleries may merge to form a single gallery. Thus, the manifold may contain a plurality of galleries and sub-galleries which branch into, and are produced by, the merging of each other.

The same flow gallery may connect one or more internal ports to one or more external ports. Fluid may flow from the same external port to both the first inlet port and the second inlet port. Fluid may flow from the first outlet port and the second outlet port to the same external port. Corresponding internal ports may be connected to an external port via the same flow gallery. Corresponding internal ports of the first and second sets may be connected to an external port via the same flow gallery. For example, fluid may flow from a pressurised supply port to both the first inlet port and the second inlet port via an inflow gallery. Fluid may flow from both the first outlet port and the second outlet port to a tank port via an outflow gallery. Fluid may flow between both the first A-control port and the second A-control port to an external A-control port via a first control gallery. Fluid may flow between both the first B-control port and the second B-control port to an external B-control port via a second control gallery. By dividing the flow gallery into sub-galleries so that corresponding internal ports connect to an external port via a single gallery, the servo-valve may advantageously combine internal ports having a size such that they can be quickly closed-off by the spool with external ports that permit sufficient fluid flow to operate the actuator.

The spool may include one or more lands. The spool may include one or more grooves. The one or more grooves may be defined between the one or more lands. The spool may be substantially cylindrical. The spool may have a first end and a second end. In use, fluid may flow through the valve via the grooves. In use, fluid may flow through the cavity via the grooves. The spool may be mounted for movement. The spool may be mounted for movement from a first position to a second position. In the first position the surface of the spool may cover the first inlet port and the second inlet port. In the first position the surface of the spool may cover the first A-control port and the second A-control port. Thus, in the first position the surface of the spool may cover the internal ports such that fluid cannot flow through the cavity.

In the second position the first inlet port and the second inlet port may each be aligned with one of said grooves. In the second position the first A-control port and the second A-control port may each be aligned with one of said grooves.

The servo valve may comprise a spool including one or more grooves wherein the spool is mounted for movement from a first position in which the surface of the spool covers at least one of the first inlet port and the second inlet port or the first A-control port and the second A-control port to a second position in which the first inlet port, the second inlet port, the first A-control port and the second A-control port are each aligned with one of said grooves. In the second position the first inlet port and the second inlet port may each be aligned with one of said grooves such that fluid flows from the inlet ports to the grooves. In the second position the first A-control port and the second A-control port may each be aligned with one of said grooves such that fluid flows from the groove to the control ports. The spool may include a first groove aligned with the first inlet port. The spool may include a second groove aligned with the second inlet port. In the second position the first A-control port may be aligned with the first groove. In the second position the second A-control port may be aligned with the second groove. In the second position fluid may flow from the first inlet port to the first A-control port via the first groove. In the second position fluid may flow from the second inlet port to the second A-control port via the second groove. A first flow path of the fluid may be as follows (in order): first inlet port, first groove, first A-control port. A second flow path of the fluid may be as follows (in order): second inlet port, second groove, second A-control port.

The spool may include a third groove. In the second position the first outlet port and the first B-control port may be aligned with the third groove such that fluid flows from the first B-control port to the first outlet port via the third groove. The spool may include a fourth groove. In the second position the second outlet port and the second B-control port may be aligned with the fourth groove such that fluid flows from the second B-control port to the second outlet port via the fourth groove. A third flow path of the fluid may be as follows (in order): first B-control port, third groove, first outlet port. A fourth flow path of the fluid may be as follows (in order): second B-control port, fourth groove, second outlet port.

The spool may be mounted for movement from the first position to a third position. The spool may be mounted for movement in a first direction from the first position to the second position. The spool may be mounted for movement in a second direction from the first position to the third position. The first direction may be opposite to the second direction. The spool may be mounted for axial movement between the first position and the second position. The spool may be mounted for axial movement between the first position and the third position.

In the third position an A-control port of the first set and an outlet port of the first set may be aligned with a groove such that fluid flows from the A-control port to the outlet port via the groove. In the third position an A-control port of the second set and an outlet port of the second set may be aligned with a groove such that fluid flows from the A-control port to the outlet port via the groove. In the third position a B-control port of the first set and an inlet port of the first set may be aligned with a groove such that fluid flows from the inlet port to the B-control port via the groove. In the third position a B-control port of the second set and an inlet port of the second set may be aligned with a groove such that fluid flows from the inlet port to the B-control port via the groove. In the third position a flow path of the fluid may be as follows (in order): inlet port, groove, B-control port. In the third position a flow path of the fluid may be as follows (in order): A-control port, groove, outlet port.

Because the servo-valve has more than one set of internal ports connected to the same actuator, the displacement of the spool between the first position and the second position and between the first position and the third position may advantageously be reduced compared to the displacement required in a servo valve with a single set of internal ports. Smaller movements may be advantageous in that they may be quicker or that they may be easier to achieve using a rotary-to-linear converter.

Each internal port may have a non-circular cross-section. Each internal port may be of elongate shape. That is to say that the internal port may extend over a greater circumferential distance than an axial distance. It will be understood that the circumferential and axial distances are relative to the manifold.

Each internal port may have a substantially rectangular cross-section. Each internal port may be a substantially rectangular slit in the inner surface of the manifold which defines the cavity. Therefore, each fluid port may be much smaller in the axial direction and therefore allow the corresponding features of the spool and manifold to be more closely packed in that direction than a typical, circular cylindrical, fluid port. Closely packing the features in the axial direction may further reduce the displacements required to operate the valve.

The circumferential extent of a port may vary with respect to the axial length of the port. Thus, the shape of the port may be tailored to the characteristics of the drive train of the spool valve. The circumferential extent of the port may vary nonlinearly with respect to the axial length of the port. The circumferential extent of the port may vary sinusoidally with respect to the axial length of the port.

The valve may comprise a third set of internal ports including a third inlet port, a third outlet port, a third A-control port and a third B-control port.

The valve may comprise further sets of internal ports each further set including a further inlet port, a further outlet port, a further A-control port and a further B-control port. The spool may include further grooves.

The spool may be located within the manifold cavity such that there is substantially no gap between the surface of the spool where a groove is not present and the inner surface of the manifold cavity. Thus, the surface of the spool may be in contact, as herein defined, with the inner surface of the cavity. “in contact” as herein defined means that any gap between the inner surface of the cavity and the surface of the spool is small enough that internal leakage of fluid is less than 5% of the flow through the valve. Therefore fluid flow around the spool, other than via a groove, may be prevented. Thus, contact between the spool and the inner surface of the manifold may be defined as the spool and the inner surface of the manifold being sufficiently close together to prevent significant flow between the inner surface of the cavity and the surface of the spool. For example, the clearance between the spool and the inner surface may be 5 μm or less. In this way precise control of the fluid flow through the valve is achievable, as the amount of flow is the result of the degree of alignment between the groove and the fluid inlet/outlet.

The manifold may include an integral sleeve. The sleeve may be located within the cavity of the manifold. The sleeve may be substantially cylindrical in shape. The sleeve may be hollow. The spool, sleeve and manifold cavity may be concentric. The spool may be located within the sleeve. The sleeve may divide the annular cavity surrounding the spool into at least two concentric annular zones. It may be that the sleeve does not extend along the majority of the length of the spool. The sleeve may divide the annular cavity surrounding the spool into at least two concentric annular zones over a portion of the length of the spool.

Proximate to each inlet port there may be a high pressure zone. Proximate to each control port there may be a high pressure zone. Each high pressure zone may have a sleeve. The sleeve may act to pressure-balance the interface between any incoming fluid and the spool. The inner surface of the manifold may include a plurality of internal ports. Thus, the manifold cavity may include a plurality of sleeves. The sleeves may be spaced apart longitudinally along the length of the spool. The central annular zone may be between the inner surface of the sleeve and the outer surface of the spool. The outer annular zone may be between the outermost surface of the sleeve and the inner surface of the manifold which forms the cavity. Thus, a spool may be mounted concentrically within a portion of the manifold such that an annular cavity is formed between the spool and the manifold and the sleeve divides the annular cavity into at least two concentric annular zones along a portion of the length of the spool. Each sleeve may include one or more apertures to allow fluid to flow into the central annular zone from the outer annular zone. A sleeve may include a single aperture, extending around the circumference of the sleeve. Alternatively a sleeve may include a plurality of holes, spaced apart around the circumference of the sleeve, to allow fluid to flow from the outer annular zone to the central annular zone.

The spool may be located in the cavity such that there is substantially no gap between the surface of the spool and the inner surface of the sleeve. A spool covering an aperture associated with an internal port may be said to cover that port. A groove aligned with an aperture associated with an internal port may be said to be aligned with that port.

The internal ports of one set may be interspersed along the longitudinal axis of the spool with the internal ports of another set. A set may overlap another set along the longitudinal axis of the spool. The internal ports of each set may be grouped separately from the internal ports of any other set along the longitudinal axis of the spool. Each set may be spaced apart from any other set along the longitudinal axis of the spool.

Each set may have the same number of ports. The first set may have the same number of ports as the second set. Each set may have the same number of ports in each category. For example, each set may have the same number of inlet ports. Each set may have the same number of outlet ports. Each set may have the same number of A-control ports. Each set may have the same number of B-control ports. Each port in the first set may have a corresponding port in the second set.

The internal ports of a set may be spaced along the longitudinal axis of the spool. The order of the ports along the longitudinal axis of the spool may be the same for each set. That is to say, corresponding ports may be in the same position relative to the other ports in each set. For example, the order of ports along the longitudinal axis may be as follows: inlet port, A-control port, outlet port, B-control port. Each control port may be positioned between an inlet port and an outlet port along the longitudinal axis of the spool.

The internal ports of a set may be spaced around the circumference of the spool. Each control port may be at 180 degrees to a fluid inlet. Each control port may be at 180 degrees to a fluid outlet.

Each set may have the same number of ports in each category and each port may be in substantially the same position relative to the other ports.

The configuration of internal ports in the second set may be substantially the same as the configuration of internal ports in the first set. The configuration of internal ports in the second set may be identical to the configuration of internal ports in the first set.

Advantageously, the arrangements described above may simplify the layout of the grooves on the spool and the control movements required.

The servo valve may comprise a motor. The servo valve may comprise a drive member. The drive member may be connected to the motor. The drive member may be arranged and configured to move the spool. The drive member may contact the spool in the region of the first end of the spool. The drive member may contact the spool in the region of the centre of the spool. The longitudinal axis of the drive member may be perpendicular to the longitudinal axis of the spool. The first set of internal ports and the second set of internal ports may be located either side of the drive member. The first set of internal ports and the second set of internal ports may be located on the same side of the drive member.

According to another aspect of the invention there is provided a method of controlling a hydraulic system, the method comprising the steps of:

i. providing a servo valve having a first set of internal ports including a first inlet port, a first outlet port, a first A-control port and a first B-control port and a second set of internal ports including a second inlet port, a second outlet port, a second A-control port and a second B-control port; and
ii. connecting the servo valve to the hydraulic system such that each of the internal ports is in fluid communication with the hydraulic system.

Thus, both sets of internal ports may be used to control the same hydraulic system.

The servo valve may be connected to an actuator. The servo valve may be connected to the actuator via one or more external ports. The servo valve may control the actuator. The actuator may have a first chamber. The actuator may have a second chamber. Each A-control port may be connected to the first chamber such that fluid flowing out of the cavity through the A-control port increases the pressure in the first chamber. The A-control port may be connected to the first chamber via an external A-control port. Each B-control port may be connected to the second chamber such that fluid flowing out of the cavity through the B-control port increases the pressure in the second chamber. The B-control port may be connected to the second chamber via an external B-control port. The valve may be arranged and configured such that, in use, an inlet port is in fluid communication with the first chamber or the second chamber via the cavity and a control port depending on the position of the spool. The valve may be arranged and configured such that, in use, an outlet port is in fluid communication with the first chamber or the second chamber via the cavity and a control port depending on the position of the spool.

Increasing the pressure in the first chamber may cause the actuator to move in the first output direction. Increasing the pressure in the second chamber may cause the actuator to move in the second output direction. The first output direction may be opposite to the second output direction. Increasing the pressure in the first chamber may increase the pressure in the second chamber such that fluid is forced out of the second chamber. Thus, increasing the pressure in the first chamber via the A-control ports may cause fluid to return to the tank via the B-control ports. Equally, increasing the pressure in the second chamber via the B-control ports may increase the pressure in the first chamber such that fluid returns to the tank via the A-control ports.

The servo valve may be connected to a hydraulic motor. The servo valve may control the hydraulic motor. The hydraulic motor may have a first motor port. The hydraulic motor may have a second motor port. Each A-control port may be connected to the first motor port such that fluid flowing out of the cavity through the A-control port drives the hydraulic motor in a first output direction. Each A-control port may be connected to the first motor port via an external A-control port. Each B-control port may be connected to the second motor port such that fluid flowing out of the cavity through the B-control port drives the hydraulic motor in a second output direction. Each B-control port may be connected to the second motor port via an external B-control port.

It may be that the valve comprises a spool including two or more grooves and the method comprises the step of:

i. moving the spool between a first position in which at least one of the first inlet port and the second inlet port or the first A-control port and the second A-control port are each covered by the surface of the spool and a second position in which a first groove is aligned with the first inlet port and the first A-control port such that fluid flows from the first inlet port to the first A-control port via the first groove and a second groove is aligned with the second inlet port and the second A-control port such that fluid flows from the second inlet port to the second A-control port via the second groove.

Thus, moving the spool from the first position to the second position allows fluid to flow from the pressurised supply to the first chamber of the actuator. Moving the spool from the first position to the second position may align the third and fourth grooves with the B-control ports such that fluid from the second chamber returns to tank via the outlet ports. By having more than one of each type of port the size of the ports may be smaller and the movement of the spool correspondingly reduced.

It may be that the method comprises the step of:

ii. moving the spool between the first position in which at least one of the first inlet port and the second inlet port or the first A-control port and the second A-control port are each covered by the surface of the spool and a third position in which a groove is aligned with the first inlet port and the first B-control port such that fluid flows from the first inlet port to the first B-control port via the groove and another groove is aligned with the second inlet port and the second B-control port such that fluid flows from the second inlet port to the second B-control port via the other groove.

Thus, moving the spool from the first position to the third position allows fluid to flow from the pressurised supply to the second chamber of the actuator. Moving the spool from the first position to the third position may align the further grooves with the A-control ports such that fluid from the first chamber returns to tank via the outlet ports.

The step of providing the valve may include producing the valve using an additive manufacturing process. The step of producing the valve using an additive manufacturing process may include producing the spool using an additive manufacturing process. The step of producing the valve may include producing the manifold using an additive manufacturing process. Using an additive manufacturing process may, for example, allow internal port and flow gallery shapes that would not be commercially possible using subtractive manufacturing, thus allowing the use of smaller internal ports or more closely packed internal ports and correspondingly reduced control movements of the spool.

According to a second aspect of the invention there is provided a servo valve comprising a spool including an integral flexure wherein the flexure is arranged and configured for movement relative to the rest of the spool in a third direction perpendicular to the longitudinal axis of the spool. Thus the flexure may absorb motion exerted on the spool in a direction perpendicular to the longitudinal axis of the spool. Absorbing the perpendicular motion may be advantageous in that a linear, axial movement of the spool may reduce perpendicular forces between the spool and the manifold and result in less wear and consequently a longer lifespan for the valve. The flexure may also reduce backlash caused by forces transmitted from the spool to the drive member.

The flexure and the spool may be of a monolithic construction. The flexure and the spool may be formed as a single part. Thus, the flexure and the rest of the spool may be formed from the same material. Such a construction may be cost-effective to manufacture, for example, because no fittings or assembly are required.

The flexure may be arranged and configured such that movement of the flexure in a direction parallel to the longitudinal axis of the spool causes movement of the rest of the spool in a first direction. The flexure and the spool may move in phase parallel to the longitudinal axis of the spool. Thus, moving the flexure parallel to the longitudinal axis of the spool moves the rest of the spool. For example, movement of the flexure parallel to the longitudinal axis of the spool may cause the spool to move from the first position to the second position causing fluid to flow to the actuator.

The spool may be hollow. The flexure may be internal to the spool. The spool may have an inner spool cavity. The inner spool cavity may be substantially cylindrical. The flexure may extend into the spool cavity. The flexure may extend across the length of the spool cavity. The spool cavity may extend along the majority of the length of the spool. The flexure may extend along the majority of the length of the spool. The flexure may extend from a region adjacent to the first end of the spool towards the second end of the spool along the majority of the length of the spool. The flexure may extend from a region adjacent to the first end of the spool to a region adjacent to the second end of the spool. By providing the flexure within a cavity in the spool rather than mounting the flexure on the outside of the spool, the flexure may advantageously exert a more axial force on the spool. For example, that may reduce bending moments that would otherwise occur if the flexure was mounted off-axis on the spool. Reducing the bending moments may advantageously further reduce wear between the spool and the manifold.

The flexure may be attached to the rest of the spool at only one end. Thus, the flexure may be a cantilever. The flexure may be attached to the rest of the spool at both of its ends.

The flexure may be substantially planar. The flexure may have a length parallel to the longitudinal axis of the spool. The flexure may have a height defined as the extent of the flexure parallel to the longitudinal axis of the drive member. The flexure may have a thickness. The length of the flexure may be very much greater than the height. The height of the flexure may be very much greater than the thickness. Alternatively, the flexure may be substantially round in cross-section. Thus, the length of the flexure may be very much greater than the radius.

The servo valve may comprise a drive member. The drive member may be mounted for axial rotation about its longitudinal axis. The drive member may rotate clockwise about its longitudinal axis. The drive member may rotate anticlockwise about its longitudinal axis.

The drive member and spool may be arranged and configured such that rotation of the member results in linear displacement of the spool. Clockwise rotation of the member may result in movement of the spool in the first direction. Anticlockwise rotation of the member may result in movement of the spool in the second direction. The drive member may be shaped such that rotation of the shaft causes the member to exert a force on the spool. The drive member may be arranged and configured such that rotation of the shaft causes the drive member to exert a drive force on the spool in a plane perpendicular to the longitudinal axis of the drive member. The drive force may have a component perpendicular to the longitudinal axis of the spool. The drive force may have a component parallel to the longitudinal axis of the spool. The drive member may be arranged and configured to contact the spool.

The drive member may extend in a direction transverse to the longitudinal axis of the spool. The drive member may extend from a first side of the cavity towards a second, opposite, side of the cavity. The drive member may traverse the cavity. The distal end of the drive member may be located on the opposite side of the cavity to the motor.

The spool may include a bore perpendicular to the longitudinal axis of the spool. The drive member may be located in the bore. The distal end of the drive member may be located in the bore. The drive member may extend through the spool via the bore. The distal end of the drive member may be located in a bearing on the opposite side of the cavity to the motor.

The drive member may be eccentrically mounted. That is to say, the longitudinal axis of the drive member may be radially spaced apart from the axis of rotation of the component that rotates the member. Thus, rotation of the drive member may cause the drive member to exert a drive force on the spool.

The cross section of the drive member may vary with respect to the longitudinal axis of the member. A portion of the drive member may have a non-circular cross-section. A portion of the drive member may have a cross-section of variable radius. Thus, rotation of the drive member may cause the portion of the drive member to exert a drive force on the spool.

The drive member may be arranged and configured to contact the flexure. The drive member may contact the flexure in the region of the first end of the spool. The drive member may contact the flexure in the region of the centre of the spool.

The flexure may include an aperture. The aperture may be concentrically located with the bore of the spool. The drive member may be located in the aperture. The drive member may contact the flexure at the edge of the aperture. The drive member may include a needle roller bearing which surrounds the shaft in the region that contacts the spool. The needle roller bearing may allow the drive member to rotate relative to the spool. Thus, the needle roller bearing may reduce wear on the spool and the drive member.

By arranging the drive member so that it exerts a force on the flexure, which in turn results in movement of the spool, the flexure may absorb any motion of the drive member that is not axial to the spool. As a result, the rotary motion of the drive member may be translated into a linear, axial motion of the spool with the non-axial components absorbed by flexing of the flexure. That may advantageously reduce wear as the spool moves in the manifold, prolonging the life of the valve.

The drive member may rotate through an angular range of −20° to +20°. Thus the drive member may be in a first angular orientation, with the spool in the first position and a rotation of +20° (20° clockwise) of the drive member may result in the spool moving to the second position. A rotation of −20° (20° anti-clockwise) may result in the spool moving to the second position. The flexure may absorb the component of the rotation that is perpendicular to the longitudinal axis of the spool. The drive member may rotate through an angular range of −30° to +30° . The drive member may rotate through an angular range of −40° to +40°. The drive member may rotate through an angular range of −60° to +60°. The drive member may rotate through an angular range of −90° to +90°

The flexure may be arranged to reduce the overall stress experienced by the flexure during movement of the spool. The overall stress may be defined as the sum of the magnitude of the stress experienced by the flexure at each point of its range of regular movement. The range of regular movement may be defined as the range in which the spool normally operates, which may be smaller than the absolute range of movement which the spool can achieve. The flexure may be stressed when the spool is in the first position. The flexure may be stressed when the spool is in the second or third position. The stress on the flexure in the second and third positions may be equivalent. The flexure may be unstressed when the spool is in a first intermediate position located between the first position and the second position. The flexure may be unstressed when the spool is in a second intermediate position located between the first position and the third position.

The stress experienced by the flexure may be primarily generated by a stress-generating force acting on the flexure in a plane perpendicular to the longitudinal axis of the drive member. When the spool is in the first position the main stress-generating force may be in a first direction. When the spool is in the second or third position the main stress-generating force may be acting in a second direction, opposite to the first direction. Thus, the stress experienced by the flexure when the spool is in the first position may be generated by a force acting in the opposite direction to the force which generates the stress experienced by the flexure when the spool is in the second or third position. The flexure may be stressed in a first direction when the spool is in the first position and a second, opposite direction, when the spool is in the second or third position.

It will be appreciated that the optimal stress profile of the flexure with respect to the longitudinal movement of the spool will be a function of the configuration of the spool and the hydraulic system.

According to the second aspect of the invention there is also provided a method of controlling an actuator, the method comprising the steps of:

i. providing a valve including a spool having an integral flexure;

ii. exerting a drive force on the spool, the drive force having a component perpendicular to the axis of the spool and a component parallel to the axis of the spool such that the perpendicular component causes the flexure to move relative to the rest of the spool in a third direction perpendicular to the axis of the spool and the parallel component causes the spool to move in a first direction parallel to the axis of the spool.

Thus, the movement of the flexure absorbs the component of the drive force perpendicular to the longitudinal axis of the spool. Producing the flexure as an integral part of the spool simplifies manufacture by reducing the number of components and increases the reliability of the valve as there are no joints between the flexure and spool which may fail.

The majority of the drive force generated by the drive member may be parallel to the longitudinal axis of the spool. The magnitude of the parallel drive force component may be greater than the magnitude of the perpendicular drive force component.

The distance moved by the flexure parallel to the longitudinal axis of the spool may be greater than the distance moved by the flexure in the third direction. The portion of the flexure in the region of the drive member may move a greater distance than the rest of the flexure. The flexure may bend relative to the spool. If the drive member contacts the flexure in the region of the centre of the spool the centre of the flexure may be the point of maximum displacement in the third direction.

The step of providing the valve may include producing the spool using an additive manufacturing process. The step of providing the valve may include producing the spool with the integral flexure using an additive manufacturing process. Additive manufacture may be particularly advantageous in the manufacture of an integral flexure that extends within a spool cavity.

A flexure according to the second aspect of the invention may advantageously be utilised in a valve having first and second sets of internal ports according to the first aspect of the invention. As explained above, multiple sets of internal ports may reduce the length of the control movements required of the spool. That may therefore also reduce the non-axial forces on the spool since a smaller angular movement of the drive member is required to produce the desired linear translation. It will be appreciated that the non-axial displacement of the drive member may vary non-linearly with angle of rotation. When combined with a flexure as described above, that already reduced non-axial component may be absorbed efficiently by the flexure so as to result in a linear translation of the spool and reduced wear between the spool and the manifold. The combination of multiple sets of internal ports and a flexure as described above may therefore result in a particularly advantageous valve. It will therefore be understood that features from one aspect of the invention may advantageously be combined with features of another aspect of the invention.

According to a third aspect of the invention the servo valve comprises a spool and an electronically commutated motor wherein the electronically commutated motor is arranged and configured to move the spool from a first position to a second position.

The electronically commutated motor may be arranged and configured to move the motor between a first motor position and a second motor position. The electronically commutated motor may be arranged and configured to move the motor between the first motor position and a third motor position. The electronically commutated motor may be arranged and configured to move the spool between the first position and the second position. The electronically commutated motor may be arranged and configured to move the spool between the first position and a third position.

An electronically commutated motor may be defined as a motor in which an electronic controller is used to switch the phase supply to a fixed coil such that the rotor (including a permanent magnet) continues turning. This is in contrast to a non-electronically commutated motor where current is conveyed to a moving rotor by means of sliding contacts, for example a commutator or slip rings. The electronically commutated motor may include a fixed coil. The electronically commutated motor may include one or more permanent magnets. The electronically commutated motor may include a rotor. The or each permanent magnet may be mounted on the rotor. Thus, the electronically commutated motor may comprise a stationary coil and a rotor including a permanent magnet.

The electronically commutated motor may comprise a plurality of permanent magnets. A magnet may have a north pole. A magnet may have a south pole. The electronically commutated motor may include two, four or more than four poles. For example the electronically commutated motor may include six poles. Increasing the number of poles enables the torque that may be produced by the motor to be increased. It may be that in a non-electronically commutated motor increasing the number of poles decreases the useful angular range of the motor. It may be that in an electronically commutated motor increasing the number of poles does not decrease the useful angular range of the motor to the same extent. Thus an electronically commutated motor may be able to produce sufficient torque to drive a spool over a useful angular range.

The electronically commutated motor may include a Hall Effect sensor. The Hall Effect sensor may be used to determine the position of the rotor. The output voltage of the Hall Effect sensor may vary as a function of the proximity of a magnetic field. The rotor may include a reference magnet. The Hall Effect sensor may be used to determine the position of the reference magnet. The reference magnet may be in addition to the at least one permanent magnet involved in generating the motive force. The Hall Effect sensor may be positioned coaxially with the rotor. The Hall Effect sensor may be positioned on the opposite side of the motor to the spool.

A Hall Effect sensor may be arranged and configured to determine the position of the rotor within a limited angular range defined by a maximum angle in both the clockwise and anticlockwise direction. The electronically commutated motor may include only a single Hall Effect sensor. Thus, the motor may operate in a range defined by the maximum angle. The maximum angle may be greater than 40 degrees. For example the maximum angle may be 60 degrees. The maximum angle may be 90 degrees.

The motor may include a control system. The control system may vary the current to the coils depending on the output of the Hall Effect sensor. For example, the control system may switch the flow of current to the coil when the output voltage of the Hall Effect sensor exceeds a threshold value. Control systems capable of performing this function will be well known to the person skilled in the art. It will be appreciated that other feedback devices may be used, including for example Linear Variable Differential Transformers (LVDT), Rotary Variable Differential Transformers (RVDT), resolvers, and potentiometers. The use of a Hall Sensor may be advantageous as such sensors are very low cost and compact. Consequently, it may be that using a Hall Sensor reduces the overall size of the valve.

The motor may be a torque motor.

According to the third aspect of the invention there is provided a method of controlling a servo valve, the method comprising the steps of:
i. providing a servo valve including a spool and an electronically commutated motor having a stationary coil and a rotor including a permanent magnet;
ii. supplying a current to the coil such that the rotor moves from a first rotor position towards a second rotor position thereby causing the spool to move from a first spool position towards a second spool position.

The method may further comprise the steps of:
iii. sensing the position of the rotor using a Hall Effect sensor; and
iv. varying the current supplied to the coil in response to the output of the sensor.

It may be that the step of providing a servo valve including a spool and an electronically commutated motor includes using an additive manufacturing process to produce the rotor. It may be that using an additive manufacturing process to produce the rotor includes using the additive manufacturing process to distribute magnetised material within the rotor. Thus, the permanent magnet may be formed integrally with the rotor. The permanent magnet and rotor may be of a monolithic construction. Using the additive manufacturing process to distribute magnetised material within the rotor may allow greater flexibility of and more control over the location of the magnetised material within the rotor. Consequently, the magnetised material may be used more efficiently within the rotor leading to a cost benefit.

According to a fourth aspect of the invention there is provided a method of producing a servo valve, the method comprising the following steps:

i. providing a first servo valve component having a first series of regularly spaced locating means, the locating means being spaced apart by a first distance;

ii. providing a second servo valve component having a second series of regularly spaced locating means, the locating means being spaced apart by a second, different, distance;

iii. moving the first component relative to the second component until a desired relative position of the components is reached; and

iv. inserting a locking member into the locating means to retain the first and second components in the desired relative position.

Inserting a locking member into the locating means may be defined as engaging the locking member with the locating means such that movement of the component relative to the locking member is prevented.

It will be appreciated that the physical form of the locating means may vary widely in dependence on the shape of the locking member. A locating means may be defined as any feature at least partially defining an opening into which a locking member may be inserted such that the locking member cannot move relative to the component in which the locating means is formed. The opening may have one or more recesses. The opening may have one or more projections.

The locking member may take a wide variety of forms. For example the locking member may be a pin or an annular member. The locating means may be a hole into which the pin is inserted. The locating means may be a ridge. The first and second series may be a series of ridges. The ridges of the first and second series may project into a circumferential gap between the first and second components to define an opening into which an annular locking member may be inserted. The annular locking member may include a plurality of grooves corresponding to the ridges on the first and second components.

The locating means of the first component may be spaced apart from the locating means of the second component. The locking means may be inserted between the locating means of the first component and the locating means of the second component.

The desired relative position may be defined as a relative position of the first and second component in which the components are connected together such that the valve may function.

It may be that the first component of the valve includes features which must be aligned accurately with corresponding features on the second component of the valve in order for the valve to function effectively. Thus, the desired relative position may be defined as a relative position of the first and second component in which the features of the first component are accurately aligned with the corresponding features of the second component. The accumulation of manufacturing tolerances during the manufacturing process may mean that the desired relative position is not precisely known before assembly. The first and second series may form a Vernier scale in which a locating means on the first component will always be close to exact alignment with a locating means on the second component at the desired position. Thus, the two components can be aligned, and retained in the desired relative position without having to know the desired relative position before in advance. It may be that the two components can function successfully in a number of relative positions and, for ease of assembly, it is preferred that the desired relative position is not dictated by the features that connect the two components. It may be that the two components are screwed together, and must be tightened to a given torque. Thus, the desired relative position may be defined as the relative position of the first and second components when the desired torque is achieved.

The insertion of a locking member into the locating means locks the position of first and second components in a manner that can only be broken through shearing (rather than deforming) of the locking component (the locking member). Such a lock may be referred to as a “Class 1” lock and is of particular application in the aircraft industry.

A locating means on the first component may be aligned with a locating means on the second component when the first and second components are in the desired relative position. The locking member is inserted into the aligned locating means.

The first distance by which the locating means of the first series of regularly spaced locating means are spaced apart may be similar, for example within 10 per cent, or more preferably 5 per cent, of the second distance by which the locating means of the second series of regularly spaced locating means are spaced apart.

An alignment point may be defined as a point where a locating means of the first series is aligned with a locating means of the second series such that a locking member may be inserted therein. In the desired relative position, the valve may include more than one alignment point. Thus, the valve may include one or more alignment points. For example there may be two locations at the desired relative position at which the locating means of the first and second series are aligned such that a locking member may be inserted therein. Thus, it may be that the servo valve includes more than one locking member retaining the same two components. For example, it may be that the servo valve includes a first locking member and a second locking member retaining the first component and the second component.

The step of moving the first component relative to the second component may include:

i. axially aligning the first component and the second component; and

ii. rotating the first component relative to the second component.

The first component may be rotated relative to the second component until the desired relative position is achieved.

The method may further include the step of providing a third component. The third component may include a third series of regularly spaced locating means spaced apart by a third distance. The second component may include a fourth series of regularly spaced locating means spaced apart by a fourth, different, distance. The fourth distance may be different from the third distance. The third distance may be the same as the first distance. The third distance may be the same as the second distance.

The method may include the step of moving the third component relative to the second component until a desired relative position of the components is reached. The method may include the step of inserting a locking member into the locating means to retain the third and second components in the desired relative position. A locating means of the third series may be aligned with a locating means of the fourth series when the second and third components are in the desired relative position. The locking member may be inserted into the aligned locating means.

A plurality of components may be aligned one with the other. Each pair of components may be retained in its respective relative position using locating means. Thus, the locating means may provide a plurality of Vernier scales which allow a series of components to be retained in their relative positions. The method may include the step of providing further components. The further components may include further series of regularly spaced locating means. The method may include the step of moving a further component relative to another component until a desired relative position is reached. The method may include the step of inserting a further locking member into the locating means to maintain the further component and the other component in a desired relative position. A locating means of the further component may be aligned with a locating means of the other component when the components are in the desired relative position. The further locking member may be inserted into the aligned locating means.

The step of providing the first servo valve component may include producing the component using an additive manufacturing process. The step of providing the second servo valve component may include producing the component using an additive manufacturing process. Using an additive manufacturing process allows the locating means to be easily incorporated into the design of the components. The locking member may also be produced using an additive manufacturing process. Using additive manufacturing to produce the locking member allows for commercial production of locking members in a wider variety of forms than would be possible using traditional manufacturing techniques.

According to the fourth aspect of the invention there is provided a servo valve comprising

a first component including a first series of regularly spaced locating means, the locating means being spaced apart by a first distance, and

a second component having a second series of regularly spaced locating means, the locating means being spaced apart by a second, different, distance, and

a locking member, wherein

the locking member is located in the locating means such that the first and second components are retained in a desired relative position.

A locating means of the first series may be aligned with a locating means of the second series when the first and second components are in the desired relative position. The locking member may be located in the aligned locating means.

The distance between a first locating means of a series and a second locating means of the same series may be substantially the same as the distance between the second locating means and a third locating means of the same series. Thus, the locating means of a series may be regularly spaced.

The first distance may be greater than the second distance. The first distance may be in the range of 0.5 mm to 20 mm. There may be between 5 and 20 locating means of the first series over a given distance. There may be between 5 and 20 locating means of the second series over a given distance. For example, there may be 5 locating means per 90 degrees. There may be one or two or three or more locating means of the first series than locating means of the second series over a given distance. There may be one or two or three or more locating means of the second series than locating means of the first series over a given distance. The first component and the second component may each have a circular portion. The locating means may be circumferentially spaced around the circular portion. The circular portion of the first component may be concentrically located within the circular portion of the second component. The locking member may be annular and may be inserted between the circular portion of the first component and the circular portion of the second component.

Each locating means may be an indentation in the surface of the component. Each locating means may be a ridge on the surface of the component. Each locating means may be a hole in the component. The form of a locating means on the first component may be different to the form of a locating means on the second component. A locating means of the first series may have a complementary shape with respect to a locating means of the second series. For example, the locating means of the first series and the locating means of the second series may comprise semi-circular notches which, when aligned, form a circle into which a locking member may be inserted.

The locking member may be a pin, for example a substantially cylindrical pin. The locking member may be annular, for example a ring. The locking member may include features corresponding to the locating means of the components. For example, where the locating means are a series of ridges, the locking member may include a corresponding series of indentations.

The servo valve may comprise a third component including a third series of regularly spaced locating means spaced apart by a third distance and a second locking member, and the second component may include a fourth series of regularly spaced locating means spaced apart by a fourth, different, distance, wherein the second locking member is located in the locating means such that the third and second components are retained in a desired relative position. A locating means of the third series may be aligned with a locating means of the fourth series when the second and third components are in the desired relative position. The locking member may be located in the aligned locating means.

The servo valve may comprise a further component. The further component may comprise a further series of locating means.

The servo valve may include a drive shaft. The servo valve may include a motor rotor. The first component may be the drive shaft. The second component may be the motor rotor. The servo valve may include a motor casing. The servo valve may include a fluid manifold. The first component may be the motor casing. The second component may be the fluid manifold body.

The servo valve may be a direct drive valve (DDV). The servo valve may be a rotary to linear servo valve. The servo valve may be a cartridge valve.

The servo valve may include a mechanical feedback device. The servo valve may include an electrical feedback device. The servo valve may be a closed loop control system. The use of a feedback device may enable the servo valve to control the actuator to a higher degree of precision.

The dimensions of the servo valve may vary quite widely according to its application. For example, the diameter of the spool may be between 1 mm and 100 mm. The length of the spool may be between 5 mm and 100 mm. The maximum flow rate through the spool may be between 1 litre per minute and 1000 litres per minute.

According to another aspect of the invention there is provided a hydraulic system including a servo valve in accordance with the invention. The hydraulic system may include a servo valve having a first set of internal ports and a second set of internal ports wherein each internal port is in fluid communication an actuator. The hydraulic system may include a servo valve having a spool including an integral flexure. The hydraulic system may include a servo valve having an electronically commutated motor. The hydraulic system may include a servo valve including a first component and a second component aligned by a locking member located in a first series of evenly spaced locating means and a second series of evenly spaced locating means.

Any features described with reference to one aspect of the invention are equally applicable to any other aspect of the invention, and vice versa. Thus features described in relation to one aspect of the present invention may be incorporated into other aspects of the present invention and features described in respect of an apparatus of the invention may be application to a method of the invention and vice versa. For example, the servo valve of the first aspect of the invention may incorporate any of the features described with reference to the second, third and fourth aspects of the invention and vice versa.

### DESCRIPTION OF THE DRAWINGS

Various embodiments of the invention will now be described, by way of example only, with reference to the accompanying schematic drawings of which:

FIG. 1 is a cut-away plan view of a servo valve;

FIG. 2 is a perspective view of the outer housing of the servo valve of FIG. 1;

FIG. 3 is a cut-away view looking along the axis of the drive member of the servo valve of FIG. 1;

FIG. 4 is a cut-away view of the spool of the servo valve of FIG. 1;

FIG. 5 is a view of some of the components of the servo valve of FIG. 1; and

FIG. 6 is a perspective view of some of the components of the servo valve of FIG. 1.

### DETAILED DESCRIPTION

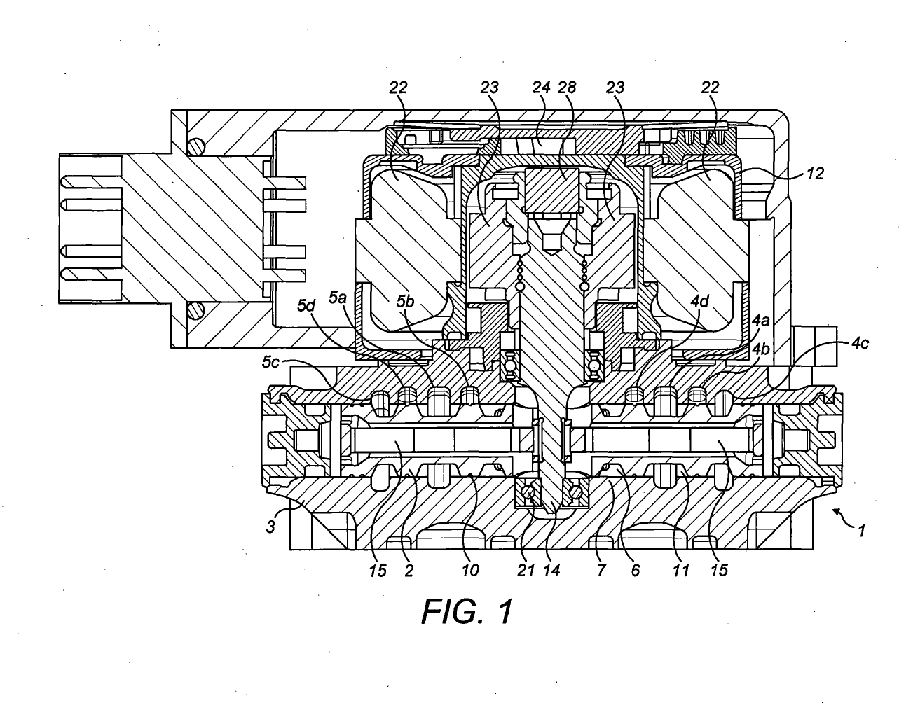

In FIG. 1, a servo valve 1 comprises a spool 2 and a fluid manifold 3. The fluid manifold 3 includes a substantially cylindrical cavity 6 defined by the inner surface 7 of the manifold 3. First and second sets of internal ports 4a-d and 5a-d are located in the inner surface 7 of the manifold 3. The spool 2 is located centrally within the manifold cavity 6 and is axially constrained within the manifold cavity 6.

The first set of internal ports 4a-d include a first inlet port 4a, a first outlet port 4c, a first control port 4b and a second control port 4d. The second set of internal ports 5a-d includes a second inlet port 5a, a second outlet port 5c, a third control port 5b and a fourth control port 5d. The two sets of ports 4a-d and 5a-d are associated with the same actuator, not shown. The internal ports 4a-d and 5a-d have an elongate, non-circular cross-section.

Each internal port 4a-d and 5a-d is in fluid communication with the internal cavity 6. In use, fluid flows into the cavity 6 via the inlet ports 4a and 5a. Fluid flows out of the cavity 6 via the outlet ports 4c and 5c. The control ports 4b and d and 5b and d act as a fluid inlets or fluid outlets depending on the position of the spool 2. Control ports 4b and 5b are categorised as A-control ports and fluid flowing out of the cavity 6 via those ports causes the actuator to move in a first output direction. Control ports 4d and 5d are categorised as B-control ports and fluid flowing out of the cavity 6 via those control ports causes the actuator to move in a second output direction.

The servo valve 1 further comprises a motor 12 and a drive member 14 connected to the motor. The drive member extends from the motor 12, through the spool 2 to a bearing 21. The first set of internal ports 4a-d and the second set of internal ports 5a-d are located either side of the drive member 14. The motor 12 is an electronically commutated motor comprising a stationary coil 22 and a rotor 23 including permanent magnets. A reference magnet 28 is attached to the rotor 23. A Hall Effect sensor 24 is positioned coaxially with the rotor 23 and is used to determine the position of the rotor by detecting the location of the reference magnet 28.

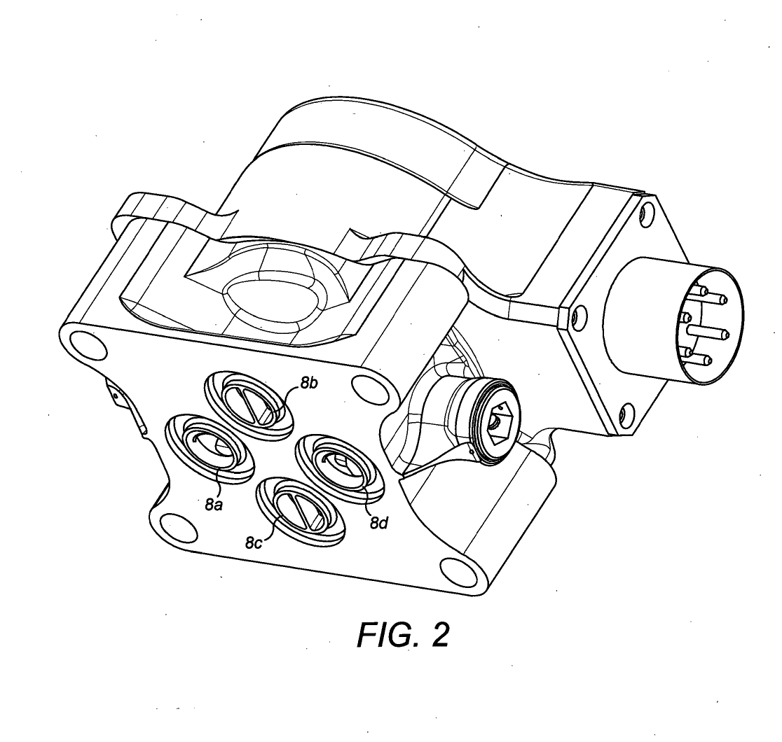

Turning to FIG. 2, the servo valve 1 includes four external ports 8a-d. The servo valve 1 is connected to a hydraulic system via the external ports 8a-d. The external ports are categorised according to function. 8a is a supply pressure port, 8b is a tank port, and 8c and 8d are external control ports.

The supply pressure port 8a is connected to a pressurised supply. Inlet ports 4a and 5a are connected to the supply pressure port 8a via the manifold 3. Thus, fluid at pressure may enter the cavity 6.

The outlet ports 4c and 5c are connected to the tank port 8b via the manifold 3. Thus, fluid from the cavity 6 is able to exit the servo valve 1 to tank.

The control ports 4b and 4d and 5b and 5d are connected to the external control ports 8c and 8d via the manifold 3. Thus, fluid from the cavity 6 is able to exit the servo valve 1 to the actuator and enter the cavity 6 from the actuator. The external control port 8c is an A-control port and is connected to the actuator such that fluid flowing out of the servo valve 1 via the A-control port 8c causes the actuator to move in the first actuator direction. The external control port 8d is a B-control port and is connected to the actuator such that fluid flowing out of the servo valve 1 via the B-control port 8d causes the actuator to move in the second actuator direction.

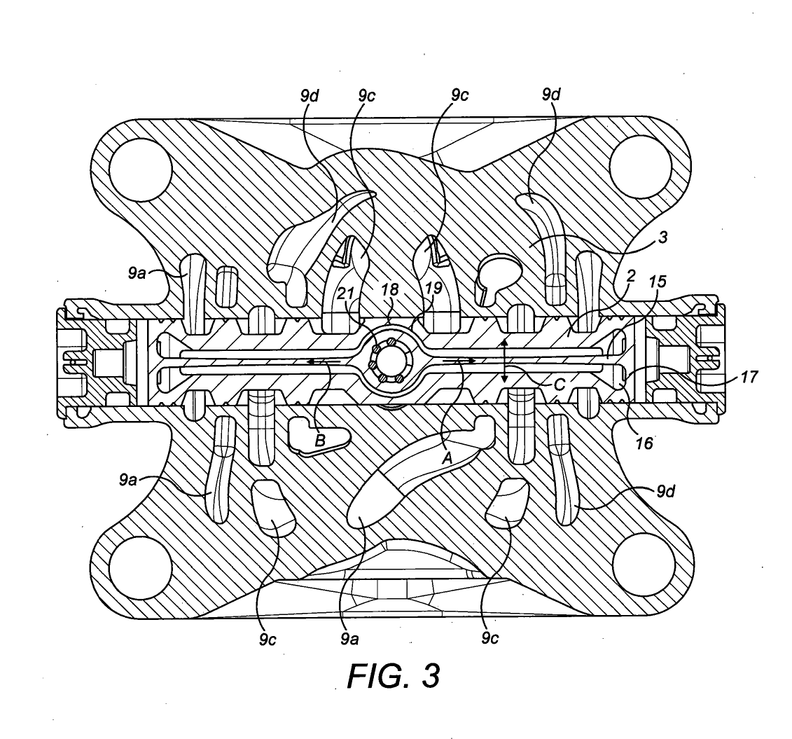

In FIG. 3 the manifold includes a plurality of flow galleries 9. The flow galleries 9 connect each internal port 4a-d, 5a-d to an external port 8a-d. A single flow gallery 9 connects one or more internal ports 4a-d to a single external port 8a-d. That is achieved by the flow gallery 9 branching into two sub-galleries. Each sub-gallery has a reduced cross-sectional area as compared to the gallery 9 from which it branches, but the sum of the cross-sectional area of all the sub-galleries is equal to that of the main gallery 9. In that way, each internal port 4a-d and 5a-d can be in fluid communication with the same hydraulic system. Thus, the internal ports 4a-d of the first set and the internal ports 5a-d of the second set are in fluid communication with the same hydraulic system and the internal ports 4a-d of the first set and the internal ports 5a-d of the second set are involved in the control of the same actuator. Inlet ports 4a and 5a are connected by sub flow galleries to the same flow gallery 9 and therefore correspond to each other. Similarly the outlet ports 4c and 5c, A-control ports 4b and 5b and B-control ports 4d and 5d correspond to each other and are linked into common flow galleries 9 via sub galleries.

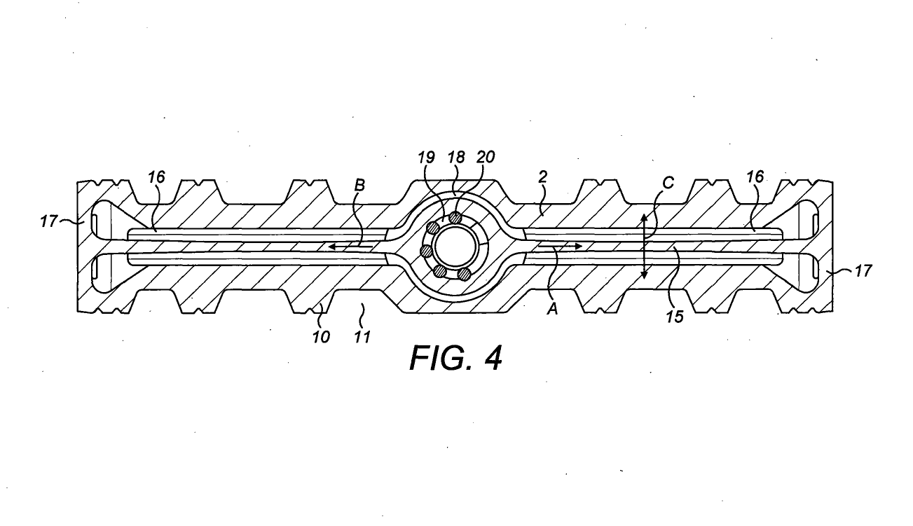

In FIG. 4 the spool 2 includes lands 10 and grooves 11. The spool 2 further includes an integral flexure 15. The flexure 15 is moveable relative to the rest of the spool 2 in a third direction C perpendicular to the longitudinal axis of the spool 2. Thus the flexure 15 absorbs force exerted on the spool 2 in direction C.

The flexure 15 and the spool 2 are of a monolithic construction.

Movement of the flexure 15 in directions A and B parallel to the longitudinal axis of the spool 2 causes movement of the rest of the spool 2 in those directions.

The spool 2 is hollow and the flexure 15 extends across the length of the cavity 16 in the spool 2. The flexure 15 merges into end portions 17 of the spool 2 and thus extends from a region adjacent to the first end of the spool 2 to a region adjacent to the second end of the spool 2.

Looking at FIGS. 1 to 4 the flexure 15 is substantially planar and its length (parallel to the longitudinal axis of the spool 2) is very much greater than its height (parallel to the longitudinal axis of the drive member 14), which in turn is very much greater than its thickness. In a particular example of the invention its length is 56 mm, its height is 15 mm and its thickness is 0.7 mm.

The drive member 14 is mounted for axial rotation, either clockwise or anti-clockwise, about its longitudinal axis. The drive member 14 extends in a direction transverse to the longitudinal axis of the spool 2. The distal end of the drive member is located on the opposite side of the cavity 6 to the motor 12 and the drive member 14 traverses the cavity 6. The spool 2 includes a bore 18 perpendicular to the longitudinal axis of the spool 2 and the drive member 14 extends through the spool 2 via the bore 18. The flexure 15 includes an aperture 19 concentrically located with the bore 18 of the spool 2. The drive member 14 is located in the aperture 19 and contacts the flexure 15 at the edge of the aperture 19. The drive member 14 includes a needle roller bearing 20 which surrounds the member 14 in the region that contacts the spool 2. The needle roller bearing 20 allows the drive member 14 to rotate relative to the spool 2 and reduces wear on the spool 2 and the drive member 14.

The drive member 14 is eccentrically mounted in bearing 21. Thus, the longitudinal axis of the drive member 14 as it passes through the needle bearing 20 in the aperture 19 is radially spaced apart from the axis of rotation, centred on the bearing 21, of the drive member 14.

The spool 2 is located within the manifold cavity 6 such that there is substantially no gap between the surface of the spool 2 where a groove is not present and the inner surface 7 of the manifold cavity 6.

The valve 1, including the spool 2 and the manifold 3 are produced by additive manufacture.

In use, the relative movement of the spool 2 and the fluid manifold 3 controls the flow of fluid through the valve in response to a mechanical or electrical input signal. In response to the signal the controller supplies a current to the coil 22 such that the rotor 23 moves from a first rotor position towards a second rotor position. The output voltage of the Hall Effect sensor 24 varies as a function of the variation of the magnetic field of the reference magnet 28 on the rotor 23 caused by movement of the rotor 23. The controller varies the current to the coils 22 depending on the output of the Hall Effect sensor 24 so as to achieve a desired rotation of the drive member 14.

The rotation of the drive member 14 causes the drive member 14 to exert a drive force on the spool 2. The drive force has components in a plane parallel to the longitudinal axis of the spool 2 and perpendicular to the longitudinal axis of the spool 2. The component parallel to the longitudinal axis of the spool 2 results in linear displacement of the spool 2. Clockwise rotation of the member 14 results in movement of the spool 2 in a first direction A and anti-clockwise rotation of the member 14 results in movement of the spool 2 in a second direction B. The flexure 15 absorbs the component of motion perpendicular to the longitudinal axis of the spool 2 by flexing relative to the spool 2. The flexure is stressed in a central position. As the flexure moves away from the central position in either direction A or B the magnitude of the stress experienced by the flexure initially decreases until the flexure is unstressed, continued movement of the flexure away from the centre position in either direction A or B results in an increase in the magnitude of the stress experienced by the flexure. In that way the overall stress on the flexure is reduced.

The spool 2 is mounted for movement in the first direction A from a first position to a second position. In the first position the surface of the spool 2 covers the internal ports 4a-d and 5a-d such that fluid cannot flow through the cavity. In the second position the inlet ports 4a-d and 5a-d are aligned with the grooves 11 such that fluid flows through the valve 1 via the grooves 11. The first and second inlet ports 4a and 5a and the first and second A-control ports 4b and 5b are aligned with the grooves 11 such that fluid flows from the inlet ports 4a and 5a to the grooves 11 and from the grooves 11 to the A-control ports 4b and 5b. The first and second outlet ports 4c and 5c and the first and second B-control ports 4d and 5d are aligned with the grooves 11 such that fluid flows from the B-control ports 4d and 5d to the grooves 11 and from the grooves 11 to the outlet ports 4c and 5c.

The spool 2 is also mounted for movement in the second direction B, opposite to the first direction, from the first position to a third position. In the third position the first and second inlet ports 4a and 5a and the first and second B-control ports 4d and 5d are aligned with the grooves 11 such that fluid flows from the inlet ports 4a and 5a to the grooves 11 and from the grooves 11 to the B-control ports 4d and 5d. The first and second outlet ports 4c and 5c and the first and second A-control ports 4b and 5b are aligned with the grooves 11 such that fluid flows from the A-control ports 4b and 5b to the grooves 11 and from the grooves 11 to the outlet ports 4c and 5c.

Thus, moving the spool 2 from the first position to the second position allows fluid to flow from the pressurised supply 8a to the first chamber of the actuator and fluid from the second chamber of the actuator to return to tank 8b via the outlet ports 4c and 5c.

Moving the spool 2 from the first position to the third position allows fluid to flow from the pressurised supply 8a to the second chamber of the actuator and fluid from the first chamber to return to tank 8b via the outlet ports 4c and 5c.

The fluid flows from pressurised supply port 8a to both the first inlet port 4a and the second inlet port 5a via inflow gallery 9. Fluid flows from both the first outlet port 4c and the second outlet port 5c to the tank port 8b via outflow gallery 9. Fluid flows between both the first A-control port 4b and the second A-control port 5b to external A-control port 8c via the first control gallery 9. Fluid flows between both the first B-control port 4d and the second B-control port 5d to external B-control port 8d via the second control gallery 9.

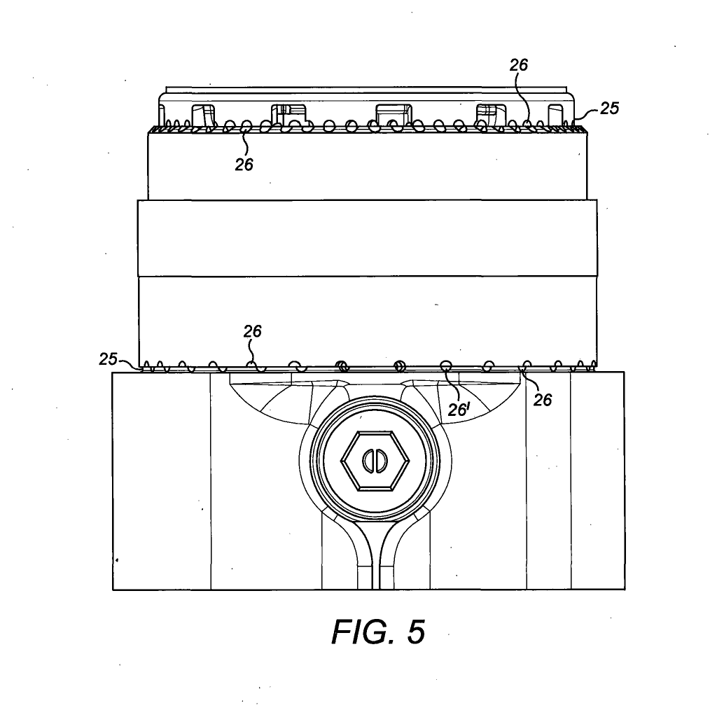

In FIG. 5, the servo valve 1 includes series of locating means 25 formed by grooves 26 in some of the components. The grooves 26 are regularly spaced, but the spacing is slightly different on adjacent components. Thus the grooves 26 on adjacent components cooperate to form a Vernier scale whereby one pair of grooves 26′ aligns to form a circular hole into which a locking member, in this case a pin, can be inserted. The adjacent components are rotated relative to one another until a desired relative position of the components is reached and a locking member is then inserted into the aligned pair of grooves 26′ to retain the components in their desired relative position.

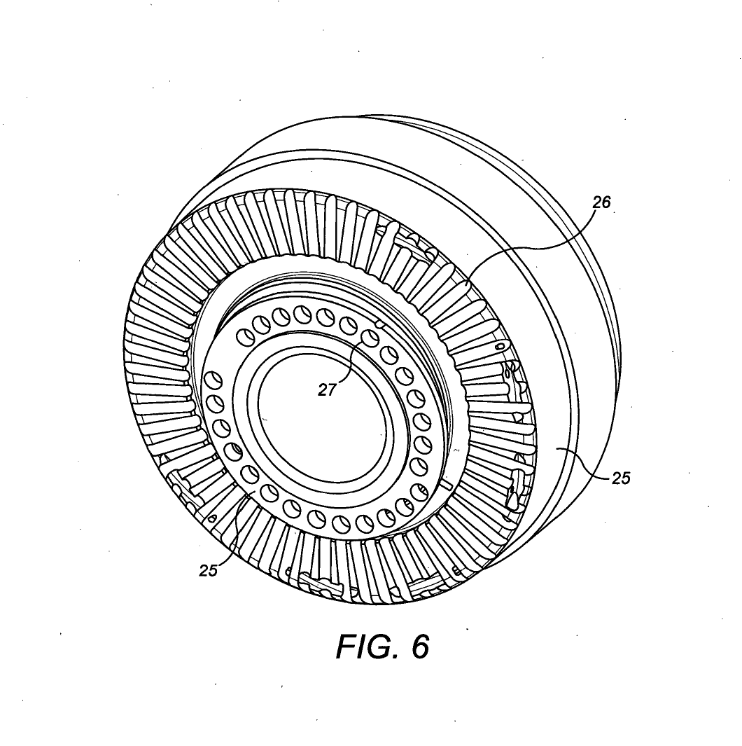

In FIG. 6, in other series 25 the components are provided with regularly spaced holes 27. Like the grooves 26 described above, the holes 27 are regularly spaced, but the spacing is slightly different on adjacent components. Thus the holes 27 on adjacent components cooperate to form a Vernier scale whereby a locking member can be inserted into the pair of holes that align.

Holes on one component may also cooperate with grooves on an adjacent component.

Whilst the present invention has been described and illustrated with reference to particular embodiments, it will be appreciated by those of ordinary skill in the art that the invention lends itself to many different variations not specifically illustrated herein. Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1-18. (canceled)

19. A servo valve comprising a spool including an integral flexure wherein the flexure is arranged and configured for movement relative to the rest of the spool in a direction perpendicular to the longitudinal axis of the spool.

20. A servo valve according to claim 19 wherein the flexure is arranged and configured such that movement of the flexure in the direction parallel to the longitudinal axis of the spool causes movement of the rest of the spool in a first direction.

21. A servo valve according to claim 19 wherein the flexure extends along the majority of the length of the spool.

22. A servo valve according to claim 19 wherein the servo valve further comprises a drive member configured and arranged to contact the flexure.

23. A servo valve according to claim 22 wherein the drive member contacts the flexure in the region of the first end of the spool.

24. A servo valve according to claim 22 wherein the drive member contacts the flexure in the region of the centre of the spool.

25. A servo valve according to claim 19 wherein the servo valve is a direct drive valve.

26. A servo valve according to claim 19 wherein the servo valve is a rotary to linear valve.

27. A hydraulic system including a spool valve according to claim 19.

28. A method of controlling an actuator, the method comprising the steps of:
i. providing a valve including a spool having an integral flexure;
ii. exerting a drive force on the spool, the drive force having a component perpendicular to the axis of the spool and a component parallel to the axis of the spool such that the perpendicular component causes the flexure to move relative to the rest of the spool in a third direction perpendicular to the axis of the spool and the parallel component causes the spool to move in a first direction parallel to the axis of the spool.

29. A method according to claim 28 wherein the magnitude of the parallel force component is greater than the magnitude of the perpendicular force component.

30. A method according to claim 28 wherein the distance moved by the flexure parallel to the longitudinal axis of the spool is greater than the distance moved by the flexure in the third direction.

31. A method according to claim 28 wherein the step of providing the valve includes producing the spool using an additive manufacturing process.

32. A servo valve comprising a spool and an electronically commutated motor wherein the electronically commutated motor is configured and arranged to move the spool from a first position to a second position.

33. A servo valve according to claim 32 wherein the electronically commutated motor comprises a stationary coil and a rotor including a permanent magnet.

34. A servo valve according to claim 33 wherein the electronically commutated motor further comprises a control system including a Hall Effect sensor such that the current supplied to the coil is varied in response to the output from the sensor.

35. A servo valve according to claim 34 wherein the rotor includes a reference magnet, and the output of the Hall Effect sensor varies in response to changes in the detected magnetic field of the reference magnet.

36. A servo valve according to claim 34 wherein a single Hall sensor is used to commutate the motor over a limited angle.

37. A servo valve according to claim 32 wherein the electronically commutated motor has at least 4 poles.

38. A servo valve according to claim 32 wherein the electronically commutated motor is a torque motor.

39. A servo valve according to claim 32 wherein the servo valve is a direct drive valve.

40. A hydraulic system including a servo valve according to claim 32.

41. A method of controlling a servo valve, the method comprising the steps of:
i. providing a servo valve including a spool and an electronically commutated motor having a stationary coil and a rotor including a permanent magnet;
ii. supplying a current to the coil such that the rotor moves from a first rotor position towards a second rotor position thereby causing the spool to move from a first spool position towards a second spool position.

42. A method according to claim 41, the method further comprising the step of:
iii. sensing the position of the rotor using a Hall Effect sensor; and
iv. varying the current supplied to the coil in response to the output of the sensor.

43. (canceled)

44. A method according to claim 41 wherein the step of providing the valve includes using an additive manufacturing process to produce the rotor.

45-56. (canceled)
